(19) United States
(12) Patent Application Publication
(10) Pub. No.: US 2022/0358942 A1
(43) Pub. Date: Nov. 10, 2022

(54) METHOD AND APPARATUS FOR ACQUIRING SEMANTIC INFORMATION, ELECTRONIC DEVICE AND STORAGE MEDIUM

(71) Applicant: Zhejiang University, Hangzhou (CN)

(72) Inventors: Feng Lin, Hangzhou (CN); Chao Wang, Hangzhou (CN); Wenyao Xu, Hangzhou (CN); Kui Ren, Hangzhou (CN)

(21) Appl. No.: 17/397,822

(22) Filed: Aug. 9, 2021

(30) Foreign Application Priority Data
May 8, 2021 (CN) 202110499193. X

(51) Int. Cl. G10L 19/03; G10L 19/26; G10L 21/0208; G10L 15/18

(52) U.S. Cl. CPC G10L 19/03; G10L 19/26; G10L 21/0208; G10L 15/1815; G10L 2021/02082

(57) ABSTRACT

A method and an apparatus for acquiring semantic information, an electronic device and a storage medium are provided. The method includes: collecting an echo signal of vibrations of a throat; performing a Fourier transform on a waveform of each period of the echo signal to obtain a spectrogram of each period, wherein the spectrograms of M periods form a spectrogram set, the spectrogram set includes M spectrograms, and the spectrograms are arranged in sequence from first to last according to a return time sequence of the corresponding echo signal; extracting a characteristic waveform of the vibrations of the throat from the spectrogram set; segmenting the characteristic waveform to obtain characteristic segments containing the semantic information; and inputting the characteristic segments into a semantic acquisition model to acquire the semantic information.

### CROSS REFERENCE TO RELATED APPLICATION

This patent application claims the benefit and priority of Chinese Patent Application No. 202110499193.X filed on May 8, 2021, the disclosure of which is incorporated by reference herein in its entirety as part of the present application.

### TECHNICAL FIELD

The present disclosure relates to the technical field of semantic recognition, and in particular to a method and apparatus for acquiring semantic information, an electronic device and a storage medium.

### BACKGROUND ART

With the rapid development of Internet of Things (IoT), IoT devices are widely used in various industries as well as our daily life. The increase of the IoT devices is also accompanied with growing man-machine interaction. As an indispensable part of man-machine interaction, semantic recognition is undergoing unprecedented development because of its convenience and high efficiency. For example, various emerging smart home appliances are increasingly adopting semantic recognition as an important means for man-machine interaction.

Most of the current semantic recognition technologies use an acoustic-based microphone to sense a human acoustic wave, to acquire human semantic information. In order to overcome the influence from an environmental noise, a computer vision based method is set forth, that is, it utilizes a camera to capture movement of a human mouth to infer human semantic information. However, the method is susceptible to the influence from light, and cannot work normally especially in a non-line-of-sight scene with visual occlusion. In addition, although a contact type microphone, such as a throat microphone, can overcome the above-mentioned disadvantages, it needs to make contact with the surface of human skin, so the contact type microphone is inconvenient to use and has poor user experience.

In the process of implementing the present disclosure, the inventors have found that the conventional art at least has the following problems:

For acoustic-based semantic recognition, a noise in an environment where an audio collection device is located will exert a great influence on a recognition effect, and therefore, the accuracy of the semantic recognition is reduced. However, the computer vision based method is susceptible to the influence from the light, and hardly works normally in the non-line-of-sight scene with the visual occlusion. Since the contact type microphone is required to make physical contact with a human body, it is inconvenient to use and has poor user experience.

In a word, the current means for acquiring the semantic information is greatly influenced by the environmental noise, and hardly works in an occluded scene. A contact type semantic acquisition method requires the physical contact between an object and skin of a user, which results in a poor user experience.

### SUMMARY

The embodiments of the present disclosure aim to provide a method and an apparatus for acquiring semantic information and an electronic device based on a frequency-modulated continuous wave and deep learning, so as to solve the technical problems, such as great influence from an environmental noise, difficulty in working in a non-line-of-sight scene, and requirement of physical contact with a user in the related technology.

Provided in the first aspect of the embodiments of the present disclosure is a method for acquiring semantic information. The method includes: collecting an echo signal of vibrations of a throat, wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar; performing a Fourier transform on a waveform of each period of the echo signal to obtain a spectrogram of each period, wherein the spectrograms of M periods form a spectrogram set, the spectrogram set includes M spectrograms, and the spectrograms are arranged in sequence from first to last according to a return time sequence of the corresponding echo signal; extracting a characteristic waveform of the vibrations of the throat from the spectrogram set; segmenting the characteristic waveform to obtain characteristic segments containing semantic information; and inputting the characteristic segments into a semantic acquisition model to acquire the semantic information.

In an embodiment, extracting the characteristic waveform of the vibrations of the throat from the spectrogram set may include:

selecting a local peak value corresponding to the speaker from each spectrogram, wherein M local peak values corresponding to the speaker are obtained in total from the spectrogram set formed by M spectrograms, and extracting a waveform formed by the M local peak values; performing a high-pass filtering on the obtained waveform; and performing a wavelet decomposition or an empirical mode decomposition on the filtered waveform, to extract the characteristic waveform containing the vibrations of the throat.

In an embodiment, inputting the characteristic segments into the semantic acquisition model to acquire the semantic information may include:

acquiring existing characteristic segments and the semantic information corresponding to the existing characteristic segments as training data, and training a neural network to obtain the semantic acquisition model; and inputting the characteristic segments into the trained semantic acquisition model for recognition, wherein the semantic acquisition model outputs the semantic information of the characteristic segments.

Provided in the second aspect of the embodiments of the present disclosure is an apparatus for acquiring semantic information. The apparatus includes:

a collection module, configured to collect an echo signal of vibrations of a throat; wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar;

a set creation module, configured to perform a Fourier transform on a waveform of each period of the echo signal to obtain a spectrogram of each period; wherein the spectrograms of M periods form a spectrogram set, the spectrogram set includes M spectrograms, and the spectrograms are arranged in sequence from first to last according to a return time sequence of the corresponding echo signal;

an extraction module, configured to extract a characteristic waveform of the vibrations of the throat from the spectrogram set;

a segmentation module, configured to segment the characteristic waveform to obtain characteristic segments containing the semantic information; and

an acquisition module, configured to input the characteristic segments into a semantic acquisition model to acquire the semantic information.

Provided in the third aspect of the embodiments of the present disclosure is an electronic device. The electronic device includes one or more processors; and a memory, configured to store one or more programs; wherein the one or more processors execute the one or more programs such that the one or processors implement the method as in the first aspect.

Provided in the fourth aspect of the embodiments of the present disclosure is a computer-readable storage medium on which computer instruction are stored, wherein steps of the method as in the first aspect are implemented when the instructions are executed by a processor.

The technical solutions provided by the embodiments of the present disclosure may include the following beneficial effects:

As can be seen from the above-mentioned embodiments, the present disclosure uses the frequency-modulated continuous radar wave to sense the vibrations of the throat of the speaker, that is, an acoustic source is directly sensed instead of an acoustic wave generated by the acoustic source, thereby preventing a sensed signal from being influenced by the environmental noise and having resistance to the environment noise. Since the used frequency-modulated continuous wave is an electromagnetic wave, which may penetrate common building materials such as a wood, glass and a drywall easily and position the acoustic source, the frequency-modulated continuous wave may penetrate an occlusion object in the non-line-of-sight scene with visual occlusion to realize non-visual sensing on the acoustic source and non-line-of-sight acquisition on the semantic information, thereby preventing the semantic information acquisition from being influenced by light. Since a used wireless sensing method is of a non-contact sensing type, the device is not required to make the physical contact with the user, and the user does not need to carry any device, which makes a more convenient use and improves the user experience.

It should be understood that the above general descriptions and the detailed description hereinafter are merely exemplary and explanatory, and should not be construed as a limitation to the present disclosure.

### BRIEF DESCRIPTION OF THE DRAWINGS

The accompanying drawings herein, which are incorporated in the specification as a constituent part of the present specification, illustrate the embodiments satisfying the present disclosure and are used to explain the principles of the present disclosure together with the specification.

FIG. 1 is a flow chart of a method for acquiring semantic information illustrated according to an exemplary embodiment; and

FIG. 2 is a block diagram of an apparatus for acquiring semantic information illustrated according to an exemplary embodiment.

### DETAILED DESCRIPTION OF THE EMBODIMENTS

The exemplary embodiments will be described in detail herein and shown in the accompanying drawings exemplarily. When the following descriptions refers to the accompanying drawings, unless otherwise specified, the same numeral in different accompanying drawings indicates the same or similar elements. The implementations described in the following exemplary embodiments do not denote all implementations consistent with the present disclosure. On the contrary, they are merely examples of an apparatus and a method consistent with some aspects of the present disclosure as detailed in the appended claims.

The terms used in the present disclosure are merely to describe the specific embodiments, instead of limiting the present disclosure. The singular forms such as “a”, “the” and “this” used in the present disclosure and the appended claims are also intended to include the plural forms, unless otherwise clearly stated in the context. It should also be understood that the term “and/or” used herein refers to and includes any of one or more of the associated listed items or all possible combinations.

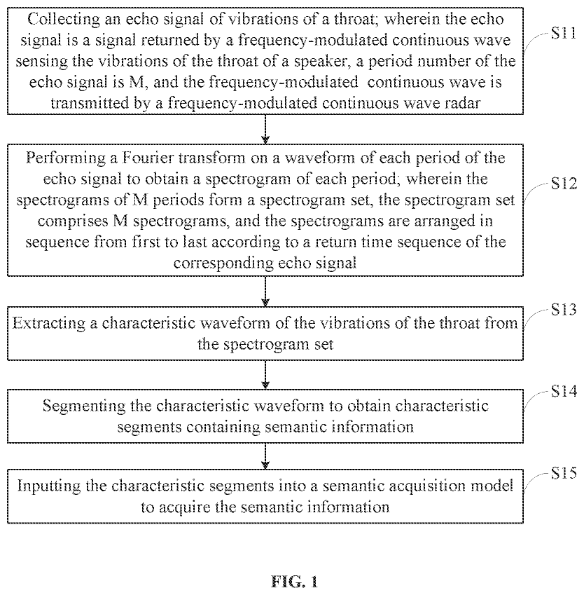

FIG. 1 is a flow chart of a method for acquiring semantic information illustrated according to one exemplary embodiment. With reference to FIG. 1, a method for acquiring semantic information provided by the embodiment of the present disclosure may include the following steps:

S11: An echo signal of vibrations of the throat is collected, wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar;

S12: A Fourier transform is performed on a waveform of each period of the echo signal to obtain a spectrogram of each period, wherein spectrograms of M periods form a spectrogram set, the spectrogram set includes M spectrograms, and the spectrograms are arranged in sequence from first to last according to a return time sequence of the corresponding echo signal;

S13: A characteristic waveform of the vibrations of the throat is extracted from the spectrogram set;

S14: The characteristic waveform is segmented to obtain characteristic segments containing the semantic information; and

S15: The characteristic segments are inputted into a semantic acquisition model to acquire the semantic information.

As can be seen from the above-mentioned embodiment, the present disclosure uses the frequency-modulated continuous radar wave to sense the vibrations of the throat of the speaker, that is, an acoustic source is directly sensed instead of an acoustic wave generated by the acoustic source, thereby preventing a sensed signal from being influenced by an environmental noise and having resistance to the environment noise. Since the used frequency-modulated continuous wave is an electromagnetic wave, which may penetrate common building materials such as a wood, glass and a drywall easily and position the acoustic source, the frequency-modulated continuous wave may penetrate an occlusion object in a non-line-of-sight scene with visual occlusion to realize non-visual sensing on the acoustic source and non-line-of-sight acquisition on the semantic information, thereby preventing the semantic information acquisition from being influenced by light. Since a used wireless sensing method is of a non-contact sensing type, a device is not required to make the physical contact with a user, and the user does not need to carry any device, which makes a more convenient use and improves the user experience.

Each step is described in detail below.

During particular implementation in S11, the echo signal of the vibrations of the throat is collected, wherein the echo signal is the signal returned by the frequency-modulated continuous wave sensing the vibrations of the throat of the speaker, the period number of the echo signal is M, and the frequency-modulated continuous wave is transmitted by the frequency-modulated continuous wave radar.

Particularly, a wireless signal is transmitted to the throat of the speaker, and the echo signal is collected by a matching collection board DCA1000. A frequency band of the transmitted frequency-modulated continuous wave is a millimeter wave frequency band of 77 GHz to 81 GHz. The radar may be a commercial radar IWR1642 produced by Texas Instruments Company. The period number M of the millimeter wave transmitted by the radar is set and transmission of a millimeter wave radar signal is controlled by using the upper computer software mmWave Studio matched with the radar. The millimeter wave frequency band can be adopted to realize a fine-grained sensing of the vibrations of the throat, and a technical threshold for the user may be lowered by using a commercial device and a software matched with the commercial device, which makes the present disclosure easier to implement.

During particular implementation in S12, the Fourier transform is performed on the waveform of each period of the echo signal to obtain the spectrogram of each period, wherein the spectrograms of M periods form a spectrogram set, the spectrogram set includes M spectrograms, and the spectrograms are arranged in sequence from first to last according to the return time sequence of the corresponding echo signal.

Particularly, the used software matched with the commercial millimeter wave radar may output the echo signal of each period in a fixed format, and the echo signals of M periods may be saved in a binary file. The binary file is read by MATLAB software, and fft ( ), a fast Fourier transform function, included in MATLAB, is used to perform the fast Fourier transform on the echo signal of each period in a receiving sequence of the echo signal to obtain the spectrogram corresponding to each period, wherein the spectrograms of M periods are arranged in a receiving sequence of the corresponding echo to form the spectrogram set. MATLAB is a commonly used commercial mathematical software, which integrates mature signal processing tools and has plenty of software interfaces, and therefore, a use threshold for the user may be lowered, and the user does not need to repeatedly implement a signal processing algorithm.

During particular implementation, S13 of extracting the characteristic waveform of the vibrations of the throat from the spectrogram set may include the following sub-steps:

(1) A local peak value corresponding to the speaker is selected from each spectrogram, wherein M local peak values corresponding to the speaker are obtained in total from the spectrogram set formed by M spectrograms, and a waveform formed by the M local peak values is extracted.

Particularly, after the Fourier transform is performed on the echo signal, a frequency on each obtained spectrogram is in direct proportion to a distance between a detected object and the millimeter wave radar, and the detected objects with different distances correspond to different local peak values on the spectrogram. The local peak value corresponding to the speaker is selected from each spectrogram, wherein M local peak values corresponding to the speaker are obtained in total from the spectrogram set formed by M spectrograms, and the waveform formed by the M local peak values is extracted. Since the vibration of the throat of the speaker will influence an amplitude of the echo, the semantic information contained in the vibration of the throat of the speaker may be accurately extracted by extracting the local peak value corresponding to the speaker.

(2) A high-pass filtering is performed on the obtained waveform.

Particularly, a fifth-order Butterworth high-pass filter may be used to perform the high-pass filtering on the obtained waveform, and a filtering operation may be implemented by functions, butter ( ) and filter ( ), of the MATLAB software. Since a frequency of human motion is lower than 20 Hz and a frequency of the vibrations of the throat is higher than 80 Hz, a cut-off frequency may be set to 80 Hz to eliminate the influence from the human motion and retain vibration information of the throat.

(3) A wavelet decomposition or an empirical mode decomposition is performed on the filtered waveform to extract the characteristic waveform containing the vibrations of the throat.

Particularly, the wavelet decomposition may be implemented by swt ( ), a static wavelet transform function, or emd ( ), an empirical mode decomposition function, of the MATLAB software. A wavelet detail component on the sixth layer after 8-layer wavelet decomposition or a component on the sixth layer after 8-layer empirical mode decomposition is selected as the characteristic waveform of the vibrations of the throat. The main reason to select wavelet transform and the empirical mode decomposition to extract the characteristic waveform is that the vibrations of the throat is weak, and the wavelet decomposition and the empirical mode decomposition have advantages in extracting a fine-grained feature, so the wavelet decomposition or the empirical mode decomposition is selected to extract the characteristic waveform of the vibrations of the throat.

During particular implementation, in S14, the characteristic waveform is segmented to obtain the characteristic segments containing the semantic information.

Particularly, during segmentation, the characteristic waveform is divided into sections with a time length of 20 ms first, and a short-time energy value of a waveform in each section is calculated. A threshold value of the short-time energy value is set as one quarter of total energy of the characteristic waveform, and a section with an energy value lower than the threshold value is regarded as a silence section. Finally, the characteristic waveform is parted by silence sections. Other sections except the silence sections form characteristic segments corresponding to words in the semantic information of the speaker. Since the characteristic waveform of the vibrations of the throat has a higher short-time energy value, vocal segments and the silence segments in the characteristic waveform may be distinguished by using the short-time energy value, wherein the vocal segment is a characteristic segment containing the semantic information.

During particular implementation, in S15, the characteristic segments are inputted into the semantic acquisition model to acquire the semantic information.

Particularly, the semantic acquisition model may use a convolutional neural network, and a residual block is introduced to better extract the semantic information contained in the characteristic segments. The data input by the neural network is the characteristic segments. The existing characteristic segments and the semantic information corresponding to the existing characteristic segments are used to training data, and the neural network is trained to obtain the semantic acquisition model. And when in use, the characteristic segments are inputted into the trained semantic acquisition model for recognition, wherein the semantic acquisition model outputs the semantic information of the characteristic segments.

The present disclosure further provides an embodiment of an apparatus for acquiring semantic information, corresponding to the embodiment of the foregoing method for acquiring semantic information.

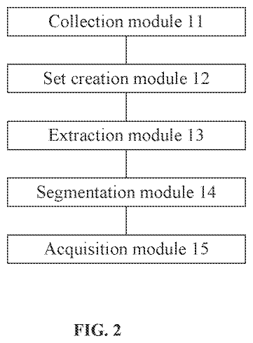

FIG. 2 is a block diagram of an apparatus for acquiring semantic information illustrated according to one exemplary embodiment. With reference to FIG. 2, the apparatus may include:

a collection module 11, configured to collect an echo signal of vibrations of a throat, wherein the echo signal is a signal returned by a frequency-modulated continuous wave sensing the vibrations of the throat of a speaker, the period number of the echo signal is M, and the frequency-modulated continuous wave is transmitted by a frequency-modulated continuous wave radar;

an set creation module 12, configured to perform a Fourier transform on a waveform of each period of the echo signal to obtain a spectrogram of each period, wherein the spectrograms of M periods form a spectrogram set, and the spectrogram set includes M spectrograms, wherein the spectrograms are arranged in sequence from first to last according to a return time sequence of the corresponding echo signal;

an extraction module 13, configured to extract a characteristic waveform of the vibrations of the throat from the spectrogram set;

a segmentation module 14, configured to segment the characteristic waveform to obtain characteristic segments containing the semantic information; and

an acquisition module 15, configured to input the characteristic segments into a semantic acquisition model to acquire the semantic information.

For the apparatus in the above-mentioned embodiment, a specific method for each module to execute an operation has been described in detail in the embodiment relating to the method, and will not be repeated herein.

For the apparatus embodiment, since it substantially corresponds to the method embodiment, it is sufficient to refer to a part of the description of the method embodiment where relevant. The apparatus embodiment described above is illustrated only schematically, where the units described as separate components may or may not be physically separated, and a component displayed as a unit may or may not be a physical unit, that is, the component may be located at one place, or distributed on multiple network units. Some or all of modules may be selected according to actual needs to implement the solutions of the present disclosure. Those ordinary skilled in the art can understand and implement the present disclosure without any creative effort.

Correspondingly, the present disclosure further provides an electronic device, including one or more processors and a memory configured to store one or more programs; wherein the one or more processors implement the above-mentioned method for acquiring the semantic information when the one or more programs are executed.

Correspondingly, the present disclosure further provides a computer-readable storage medium on which computer instructions are stored, wherein the instructions implement the above-mentioned method for acquiring semantic information when executed by a processor.

Those skilled in the art could easily conceive of other implementation solutions of the present disclosure upon consideration of the specification and an implementation of the contents disclosed herein. The present disclosure is intended to cover any variations, uses or adaptive changes of the present disclosure, which follow the general principles of the present disclosure and include common general knowledge or conventional technical means in the art not disclosed in the present disclosure. The specification and the embodiments are to be regarded as exemplary only, and the true scope and spirit of the present disclosure are indicated by appended claims.

It should be understood that the present disclosure is not limited to a precise structure which has been described above and illustrated in the accompanying drawings, and can have various modifications and changes without departing from the scope of the present disclosure which is limited by the appended claims only.

What is claimed is:

1. A method for acquiring semantic information, comprising:
collecting an echo signal of vibrations of a throat; wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar;
performing a Fourier transform on a waveform of each period of the echo signal to obtain a spectrogram of each period; wherein the spectrograms of M periods form a spectrogram set, the spectrogram set comprises M spectrograms, and the spectrograms are arranged in sequence from first to last according to a return time sequence of the corresponding echo signal;
extracting a characteristic waveform of the vibrations of the throat from the spectrogram set;
segmenting the characteristic waveform to obtain characteristic segments containing semantic information; and
inputting the characteristic segments into a semantic acquisition model to acquire the semantic information.

2. The method according to claim 1, wherein extracting the characteristic waveform of the vibrations of the throat from the spectrogram set comprises:
selecting a local peak value corresponding to the speaker from each spectrogram, wherein M local peak values corresponding to the speaker are obtained in total from the spectrogram set formed by M spectrograms, and extracting a waveform formed by the M local peak values;
performing a high-pass filtering on the obtained waveform; and
performing a wavelet decomposition or an empirical mode decomposition on the filtered waveform, to extract the characteristic waveform containing the vibrations of the throat.

3. The method according to claim 1, wherein inputting the characteristic segments into the semantic acquisition model to acquire the semantic information comprises:
acquiring existing characteristic segments and the semantic information corresponding to the existing characteristic segments as training data, and training a neural network to obtain the semantic acquisition model; and
inputting the characteristic segments into the trained semantic acquisition model for recognition, wherein the semantic acquisition model outputs the semantic information of the characteristic segments.

4. An apparatus for acquiring semantic information, comprising:
a collection module, configured to collect an echo signal of vibrations of a throat; wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar;
a set creation module, configured to perform a Fourier transform on a waveform of each period of the echo signal to obtain a spectrogram of each period; wherein the spectrograms of M periods form a spectrogram set, the spectrogram set comprises M spectrograms, and the spectrograms are arranged in sequence from first to last according to a return time sequence of the corresponding echo signal;
an extraction module, configured to extract a characteristic waveform of the vibrations of the throat from the spectrogram set;
a segmentation module, configured to segment the characteristic waveform to obtain characteristic segments containing the semantic information; and
an acquisition module, configured to input the characteristic segments into a semantic acquisition model to acquire the semantic information.

5. The apparatus according to claim 4, wherein extracting the characteristic waveform of the vibrations of the throat from the spectrogram set comprises:
selecting a local peak value corresponding to the speaker from each spectrogram, wherein M local peak values corresponding to the speaker are obtained in total from the spectrogram set formed by M spectrograms, and extracting a waveform formed by the M local peak values;
performing a high-pass filtering on the obtained waveform; and
performing a wavelet decomposition or an empirical mode decomposition on the filtered waveform, to extract the characteristic waveform containing the vibrations of the throat.

6. The apparatus according to claim 4, wherein inputting the characteristic segments into the semantic acquisition model to acquire the semantic information comprises:
acquiring existing characteristic segments and the semantic information corresponding to the existing characteristic segments as training data, and training a neural network to obtain the semantic acquisition model; and
inputting the characteristic segments into the trained semantic acquisition model for recognition, wherein the semantic acquisition model outputs the semantic information of the characteristic segments.

7. An electronic device, comprising:
one or more processors; and
a memory, configured to store one or more programs; wherein
the one or more processors execute the one or more programs such that the one or processors implement a method for acquiring semantic information;
wherein the method comprises:
collecting an echo signal of vibrations of a throat; wherein the echo signal is a signal returned by a frequency-modulated continuous wave sensing the vibrations of the throat of a speaker, a period number of the echo signal is M, and the frequency-modulated continuous wave is transmitted by a frequency-modulated continuous wave radar;
performing a Fourier transform on a waveform of each period of the echo signal to obtain a spectrogram of each period; wherein the spectrograms of M periods form a spectrogram set, the spectrogram set comprises M spectrograms, and the spectrograms are arranged in sequence from first to last according to a return time sequence of the corresponding echo signal;
extracting a characteristic waveform of the vibrations of the throat from the spectrogram set;
segmenting the characteristic waveform to obtain characteristic segments containing semantic information; and
inputting the characteristic segments into a semantic acquisition model to acquire the semantic information.

8. The electronic device according to claim 7, wherein extracting the characteristic waveform of the vibrations of the throat from the spectrogram set comprises:
selecting a local peak value corresponding to the speaker from each spectrogram, wherein M local peak values corresponding to the speaker are obtained in total from the spectrogram set formed by M spectrograms, and extracting a waveform formed by the M local peak values;
performing a high-pass filtering on the obtained waveform; and
performing a wavelet decomposition or an empirical mode decomposition on the filtered waveform, to extract the characteristic waveform containing the vibrations of the throat.

9. The electronic device according to claim 7, wherein inputting the characteristic segments into the semantic acquisition model to acquire the semantic information comprises:
acquiring existing characteristic segments and the semantic information corresponding to the existing characteristic segments as training data, and training a neural network to obtain the semantic acquisition model; and
inputting the characteristic segments into the trained semantic acquisition model for recognition, wherein the semantic acquisition model outputs the semantic information of the characteristic segments.
